(19) United States
(12) Patent Application Publication
(10) Pub. No.: US 2007/0005637 A1
(43) Pub. Date: Jan. 4, 2007

(54) System for Litigation Management

(76) Inventors: Elizabeth B. Juliano, Gates Mills, OH (US); Sonya S. Virant, Chardon, OH (US)

Correspondence Address: JEANNE E. LONGMUIR, 2836 CORYDON ROAD, CLEVELAND HEIGHTS, OH, 44118, US

(21) Appl. No.: 11/428,495

(22) Filed: Jul. 3, 2006

Related U.S. Application Data
(60) Provisional application No. 60/696,097, filed on Jul. 1, 2005.
(60) Provisional application No. 60/702,190, filed on Jul. 25, 2005.
(60) Provisional application No. 60/764,543, filed on Feb. 2, 2006.

(51) Int. Cl. G06F 7/00

(52) U.S. Cl. 707/102

(57) ABSTRACT

A system for management of litigation by a litigation decision maker which system allows for secure and confidential viewing of a litigation-related electronic database by system users authorized by the decision maker. Records within the database, such as medical or legal records, may be reviewed in original image format or searchable text format, along with written explanations of the content of such records. Explanations may include abstracts, summaries or other documents prepared by individuals authorized by the litigation decision maker who are qualified to review and assess such records. Additionally, chronologies, timelines or reports may be generated according to predetermined requirements established by the litigation decision maker. The authorized system user has substantially continuous access to the electronic database remotely from the computer system for viewing, obtaining by printing or electronic downloading or providing information regarding the litigation or litigations via the internet.

### CROSS-REFERENCE TO RELATED APPLICATIONS

The present application claims priority from, and incorporates herein by reference, the subject matter of U.S. Application Ser. Nos. 60/696,097 filed Jul. 1, 2005; 60/702,190 filed Jul. 25, 2005, and 60/764,543 filed Feb. 2, 2006.

### FIELD OF INVENTION

The present invention relates to an internet or web based system for managing litigation, and more specifically for management of all aspects of legal and other information related to or involved with large or small scale litigation matters. In particular, this system or method assists decision makers, such as legal, corporate or insurance professionals, to obtain and access records and clarifying documents from third parties, such as the court, opposing counsel, court reporters, medical, governmental or other document providers (e.g., a doctor, employer or regulatory compliance agency), using a computer network which facilitates access by multiple users, 24 hours per day, 365 days per year.

### BACKGROUND OF THE INVENTION

Various corporations and other decision making entities rely heavily on a variety of information to make legal, business and other critical decisions in connection with potential, pending or settled litigation matters. Large volumes of litigation related electronic and paper data are maintained by such entities, including insurance companies, corporations such as pharmaceutical manufacturers, chemical manufacturers, medical device manufacturers, and attorneys. Medical records in particular are typically generated by “providers,” such as doctors, hospitals and independent diagnostic laboratories, for example. In connection with all aspects of litigation matters, decision makers are called upon to sift through, analyze and produce relevant and requested data, which is labor intensive and expensive. Often, particularly in litigation involving mass torts, many requesters and reviewers of medical and other information records function independently. Independent processing may result in further redundant costs as the same information is requested, obtained, reviewed and disseminated multiple times and in multiple ways and formats. In addition to the undue requests and reviews, available efficiencies are not achieved by sharing the work products generated and using central communication with multiple users authorized by the decision makers.

Prior art systems have attempted to manage such litigation information using a variety of techniques. U.S. Pat. No. 5,159,180 enables electronic database collection by scanning, and storage and retrieval using bar coding techniques. Additionally, U.S. Pat. No. 6,738,760 provides the use of artificial intelligence to retrieve relevant legal information from electronic databases.

It would be useful to provide accurate, comprehensive, timely and continuously accessible medical information via an internet website either for viewing, printing or downloading. Many legal firms employ individuals who possess medical or other technical backgrounds or can research medical or other technical issues. However, a large scale information system has not been previously available which is capable of handling medical or technical data, images and reports for a variety of clients and purposes. Such a system would allow many individuals to simultaneously access work products and electronically share information to prepare case matters.

### SUMMARY OF THE INVENTION

The litigation management system of the present application enables generation of a secure and confidential electronic database of litigation records gathered and summarized by authorized decision makers or system users, which records may be retrieved, reviewed, printed or downloaded. The system includes record retrieval processes, record review and reporting processes, processes for managing the flow of an individual litigation matter, as well as large numbers of case matters and software for implementing these processes. The system contains information or records including, pleadings, medical records, employment, social security, educational, worksite records (e.g., regulatory compliance), deposition transcripts, expert witness information, product and project files, briefs, motions and court orders and analytical work product, with desired and designated information being available in both original image and searchable text formats, along with written explanations of the content of such records. Explanations may include abstracts, summaries or other documents prepared by individuals authorized by the litigation decision maker who are qualified to review and assess such records, such as registered nurses, physicians or other health or technical professionals. Additionally, chronologies, timelines or reports may be generated according to predetermined requirements established by the litigation decision maker.

Increased efficiencies are obtained for litigation decision makers and their clients in the process of obtaining and electronically storing and summarizing records from a provider on behalf of decision makers, sharing information among users authorized by the decision makers, and reviewing and reporting on system database or record information in preparation of the litigation matter. By facilitating record gathering, storage, information analysis and case management (e.g., deadline management, attorney assignments, issue analysis), the present system reduces costs and time in dispute resolution.

In one embodiment of the present system, litigation records are gathered, summarized and stored in a database by authorized users all located remotely from the decision makers. In a second application service provider embodiment, the litigation records are gathered and summarized under the direct supervision of the decision makers, and stored in a database maintained remotely from the decision makers. The system enables the decision makers or system users to themselves enter and create a computer database of medical and legal or litigation information that integrates data capture, correspondence, time tracking, billing, imaging, product delivery and project tracking. The system provides a user with the flexibility to customize the system such that it may be integrated with and incorporate a variety of existing third party software which provides certain of the functions mentioned, for example, with prevalent legal case management systems, or for purposes of correspondence, programs such as Microsoft Outlook or Lotus Notes may be integrated and the data from such systems incorporated.

In either embodiment, access to records within the database is enabled for all users or providers authorized by the decision makers via a secure web or internet based computer system using individualized passwords, which also enable the use of a “what's new” feature by which new or updated information is identified for the user since they last accessed the system or from a specified date.

### BRIEF DESCRIPTION OF THE DRAWINGS

For a more complete understanding of the present system, reference is now made to the following descriptions taken in conjunction with the accompanying drawings, in which:

FIG. 1 schematically illustrates certain computer, electronic and communication components of an embodiment of the litigation management system of the present application and its implementation.

FIG. 2 schematically illustrates certain computer, electronic and communication components of another embodiment of the litigation management system of the present application and its implementation.

FIG. 3 is a sample illustration of data fields within a predetermined data table where record information is electronically stored with respect to a subject associated with a litigation matter in the present system.

FIG. 4 schematically illustrates the web architecture of the present system.

FIG. 5 schematically illustrates aspects of the web folder structure organization for the present system.

FIG. 6 schematically illustrates an initial display screen image of the present system where litigation information stored within the system database may be selected or searched by a decision maker or user.

FIG. 6a schematically illustrates the Overview of Litigation information provided to a user upon use of this selection in the display screen of FIG. 6.

FIG. 6b schematically illustrates the use of a geographic map display screen image which enables a user to select record information by highlighting a desired state.

FIG. 7 schematically illustrates certain of the subject information which is stored within the database of the present application and is available for searching by users of the system.

FIG. 8 schematically illustrates a display screen image of the outstanding issues report of the present system.

FIG. 9 schematically illustrates a display screen image showing the demographic information for a subject and a record acquisition (RA) status report regarding the subject stored in the database of the present system.

FIG. 10 schematically illustrates a display screen image of an expanded view of the record acquisition status report information shown in FIG. 9.

FIG. 11 schematically illustrates a display screen image of a request to download specific records of a subject.

FIG. 12 schematically illustrates a display screen image of a split screen image showing both a searchable text work product document and an image version of the text document.

FIGS. 12a and 12b schematically illustrate display screen images of a record image document selected for viewing by a user of the present system.

FIGS. 13 and 14 schematically illustrate display screen images showing how the user may download various reports (as in FIG. 13) and order or download various records (as in FIG. 14).

FIGS. 15 and 16 schematically illustrate display screen images showing a pathology itemization report and a radiology itemization report, respectively.

FIG. 17 schematically illustrates a display screen image where a user may select a compilation report be generated for viewing, downloading or printing from the system of the present application.

FIG. 18 schematically illustrates a display screen image showing a portion of summary information (with confidential information redacted) from a subject report of a variety of record information generated by the present system.

FIG. 19 schematically illustrates a display screen images showing portions of a table of summary injury information (with confidential information redacted) where the Injury view feature button is selected.

FIG. 20 schematically illustrates (with confidential information redacted) a bar graph of a portion of injury information selected using the Age view feature button.

FIG. 21a schematically illustrates an image showing the display screen used by a user of the present system to select the fields desired to appear in a compilation report.

FIGS. 21b and 21c schematically illustrate additional images showing the display screens used by a user of the present system to select the search criteria from within the system database that a user desires to include in a compilation report.

FIGS. 22 to 38 schematically illustrate display screen images provided in connection with a second embodiment of the litigation management system of the present application.

### DETAILED DESCRIPTION OF THE SYSTEM

The following description is the best mode for presently carrying out the system of the present application. The description is not to be taken in a limiting sense, but is merely made for the purpose of describing the system. The scope of the system should be determined with reference to the claims.

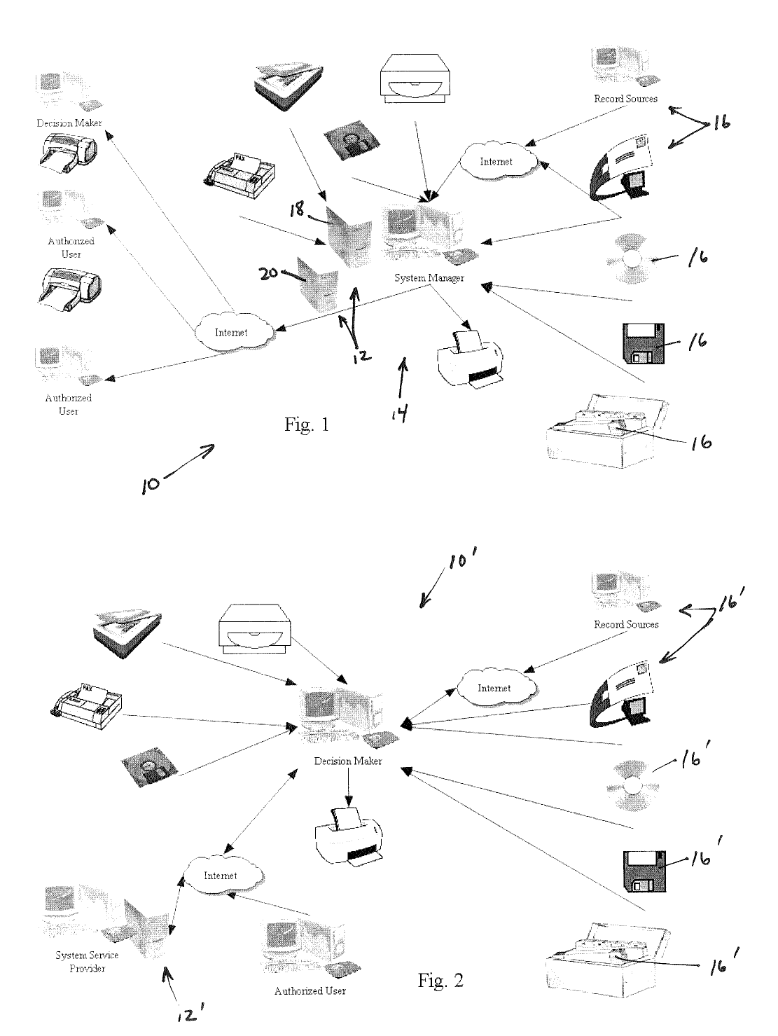

The present application, schematically illustrated in one embodiment in FIG. 1, provides a litigation management system 10 which is web-enabled to assist a litigation decision maker, system manager or other authorized user to access and use an electronic database 12 of medical and other litigation support information or records for management of an individual litigation matter or a large scale, multiple case matter. The computer implemented litigation management system 10 allows litigation decision makers, located at a computer station remote from the system manager, who are responsible for litigation outcomes to receive, review and generate information, communications, work product and records via a secure web site, as opposed to reviewing volumes of paper documents. The system facilitates the efficient and effective use and dissemination of critical case information.

The present system 10 includes an stored computer database, generally referenced at a storage site 12, of information that integrates data capture, correspondence, time tracking, billing, imaging, product delivery and project tracking into one tool for each decision maker's litigation matter or matters. The system 10 uses meta-data to dynamically create data entry screens and to store information specific to each litigation matter(s). This enables a scalable system that facilitates data capture, searching and reporting for a wide variety of uses. The system integrates medical analysis of the data pertaining to the litigation with the actual source documents or document images using available hyperlinking technology. Also, the system uses searchable data fields and searchable text versions of the source documents and, with the use of split-screen technology, may provide the decision maker with simultaneous views of the same selected records or information, for example, both the medical analysis work product and image of the source document on a single screen.

The system provides ease of use, ease of access and cost efficiency. The web or internet access aspect of the system 10 enables highly mobile and geographically diverse decision makers or their authorized users to access the information at any time from any internet location. The system 10 enables detailed searching of all aspects of the database 12 to increase access to and use of the litigation information. Costs are contained by elimination of numerous paper copies, copy and shipping expenses. Costs are also contained through the collection of data at a single point for distribution to multiple users for multiple uses.

In one embodiment of the present system, as shown in FIG. 1, litigation information or records 16 are gathered (either directly, in hard copy or electronically, or via the internet) from a variety of record sources. The records are then summarized, entered and stored in an electronic database 12 via a computer network 14 by authorized system managers, all located remotely from the decision makers, and potentially from each other. Records 16, which reference number is generally intended to refer to individual items of information stored with respect to each subject within the database 12, are electronically scanned or captured and stored, and data manually input into fields within the desired or predetermined data tables, as shown in FIG. 3, in a database server 18, preferably in a Microsoft® SQL 7.0 server, by the system manager. The database server 18 supports a Windows 2000 platform, to store the records and other aspects of the database. Specific hardware requirements also include a Dual 900 MHz Intel Pentium III Xeon, 2048 GB of memory, gigabit ethernet, a 120 GB hard drive and 200 GB storage area network. The database server 18 supports medical documents and record images in TIFF format, as well as other reports in Microsoft Word® and Adobe® formats.

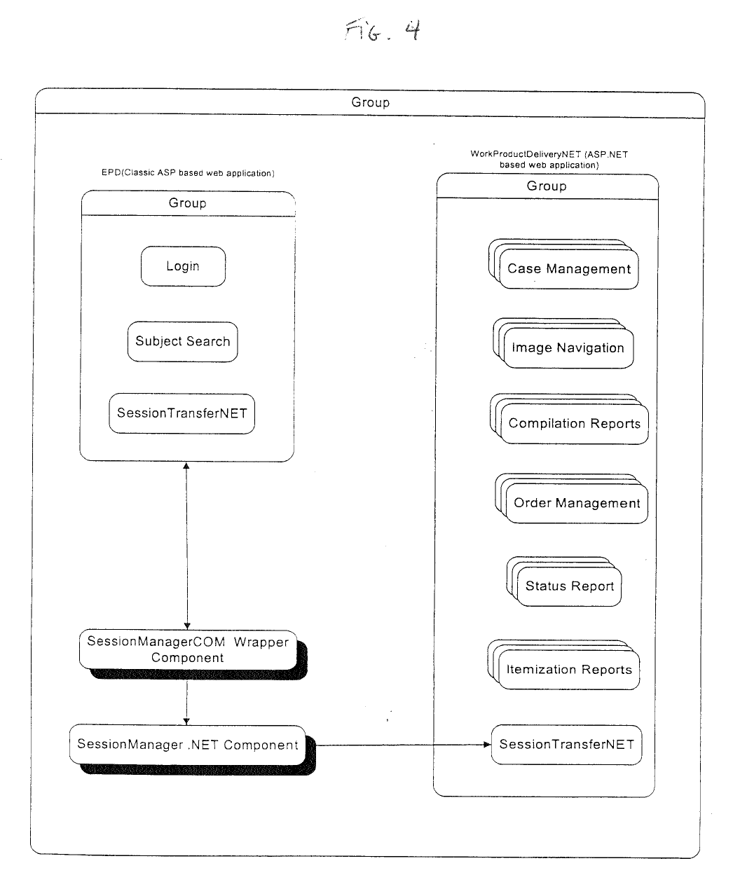

A web server 20, shown in FIG. 1, preferably at least Microsoft Internet Information Server 5.0 running on a Windows 2000 platform with .NET Framework 1.1, is also used for storage of business and data access information and user access protocols, as further shown in FIGS. 4 and 5. The specific hardware requirements include a dual 2.8 GHz Intel Pentium 4 Xeon, 1024 MB of memory, gigabit ethernet adaptors, and an 80 GB hard drive. A variety of web based software applications are used to enable secure work session access to authorized users and conduct database searching.

The system 10 also includes an electronic product delivery software application (EPD), shown in FIGS. 4 and 5, which is used in connection with the servers 18, 20 to authenticate users and establish work session and security protocols. Another web based software application, WorkProductDeliveryNET, is used to provide case management, document order management, image navigation and various reporting features within the system. Microsoft's SessionManager application, which is a NET component, is used to enable interaction between EPD and WorkProductDeliveryNET for access and manipulation of work session information. An overview of the web architecture is illustrated in FIG. 4, and a general web folder structure organization is illustrated in FIG. 5.

Once the database and web servers 18, 20 are connected and communicating, and the various COM and NET software application components are installed and registered, a new website is created and assigned the desired internet protocol address for the decision maker, and a secure server SSL certificate installed. The necessary folders are also created in the web applications, and pointed appropriately, so that the EPD and WorkProductDeliveryNET and a web reports folder all have the necessary access to the records information and session folders. Prior to creation and storage of the records or items of information 16 for each litigation matter, administrative information is also entered into the database by the system manager. Authorized user permissions limit or permit access and manipulation of various aspects of the database 12, as dictated by the decision makers. An SMTP server is also enabled so that email functionality is permitted from within and with the system 10. Finally, firewall server technologies are also enabled and the website is then available via the internet. Decision makers and authorized users accessing the password protected system continuously via the internet preferably do so using at least a DSL internet connection to a computer having at least a Pentium III processor with 256 MB RAM supporting Windows/Office 2000, Adobe Acrobat Reader, Internet Explorer 6 SPI and Alternatiff Image Viewer (www.alternatiff.com).

Specific record information 16 is entered by authorized system managers, either remotely or at the system management site. Record information newly added to the database is made available to system users within an hour of its addition. The database storage of record information within searchable fields enables litigation decision makers to review information by various criteria, including, for example: states, regions or provinces in which litigation is pending, counsel, assigned priority, deadline types and dates, work product deadlines and availability, as shown in FIG. 7. Additionally, various aspects of a subject (meaning a patient, plaintiff and/or claimant information), including case caption involving the subject, and a variety of other relevant information may be included for searching with respect to each subject, such as the information shown in FIG. 7.

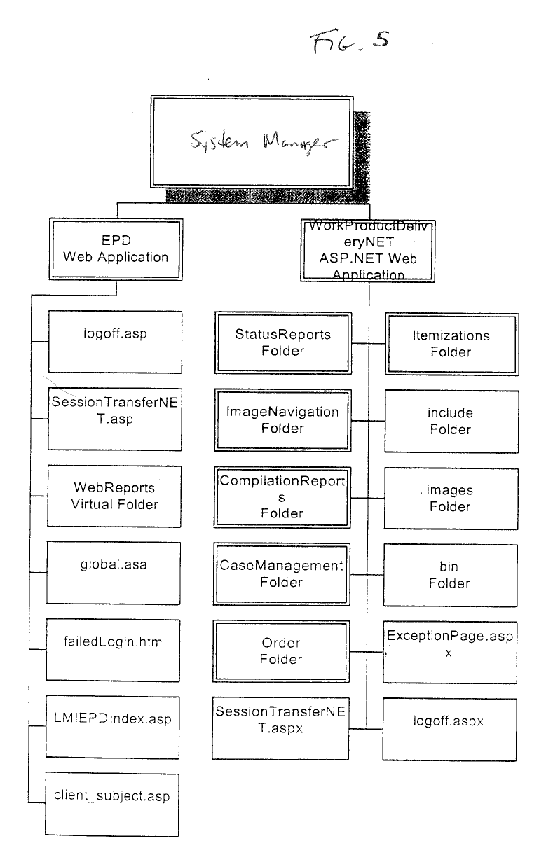

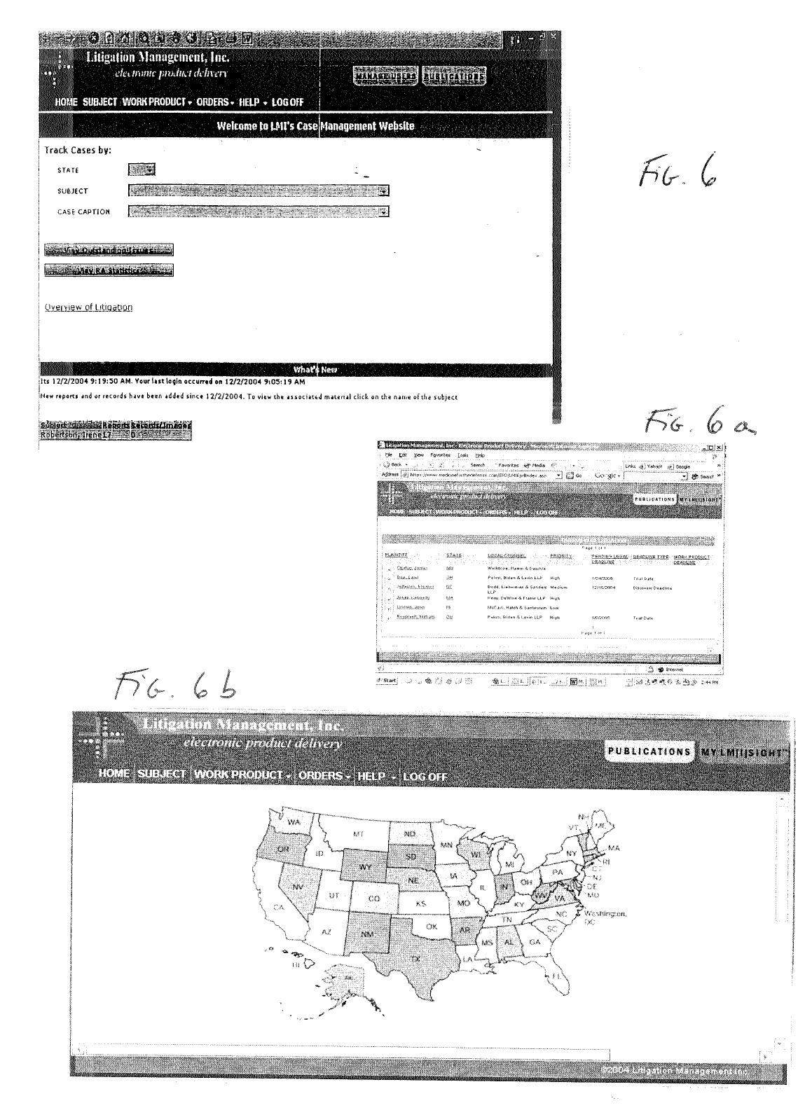

Once the system manager has been supplied with litigation matter information regarding subjects pursuant to various requests to sources, and from the decision maker, the database is created and available to the decision maker via the internet. An initial display screen image viewed by a user upon accessing the system is shown in FIG. 6. Record information 16 may be viewed by selection of or searching in one of the several available fields or button selections on this screen. By selecting the link indicated as “Overview of Litigation,” the user or decision maker is provided with an expandable listing by plaintiff name of the litigation matters, as shown in FIG. 6a. Alternatively, in large and complex litigation matters, decision makers may desire to review all pending matters in a particular state. In this instance, selection of a specific state from a geographic map view as shown in FIG. 6b will provide the user or decision maker with all litigation matters for the selected state.

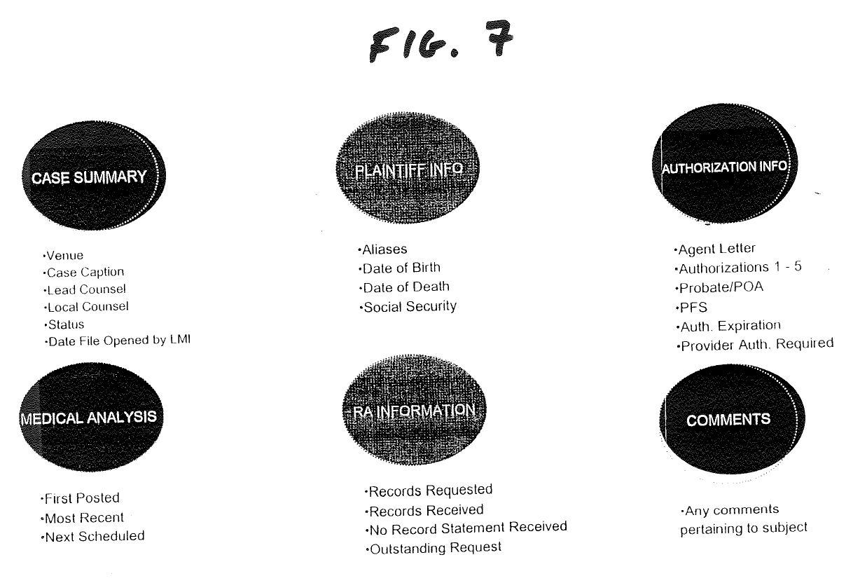

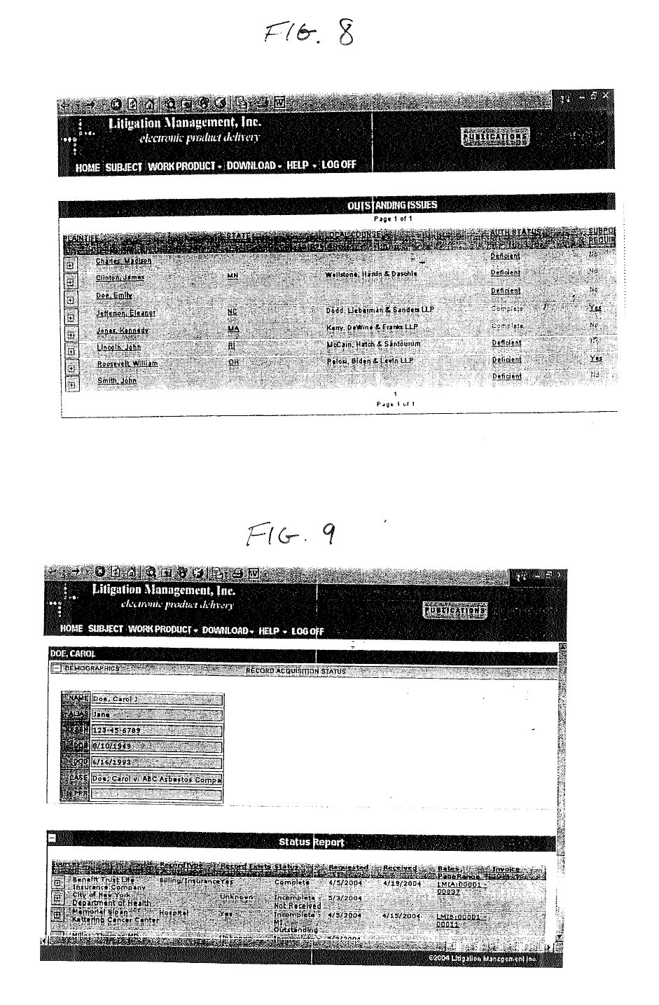

Statistics or outstanding issue reports relating to the acquisition of records with respect to each litigation matter may also be reviewed, as shown by the button selections in FIG. 6. A variety of record information 16 is provided in such reports, for example, subject demographics, geographical location, percentage complete, records requested, records collected, “no record” statements received, the number of pages collected, details of the record source or provider, including their address, specialty, affiliation and any comments, as illustrated in FIGS. 8 and 9. Once the sources of record information are identified in a record acquisition status report, as shown in FIG. 9, information regarding the specific issues may be expanded for more detailed information, as shown in FIG. 10. Statistics concerning outstanding issues impacting record collection are included, for example, status of patient authorization, subpoena requirements or other form requirements, as illustrated in FIG. 8. The system may also be instructed to generate automatic instructions to pursue record collection from sources, and the associated approval/non-approval email for such collection to all necessary parties.

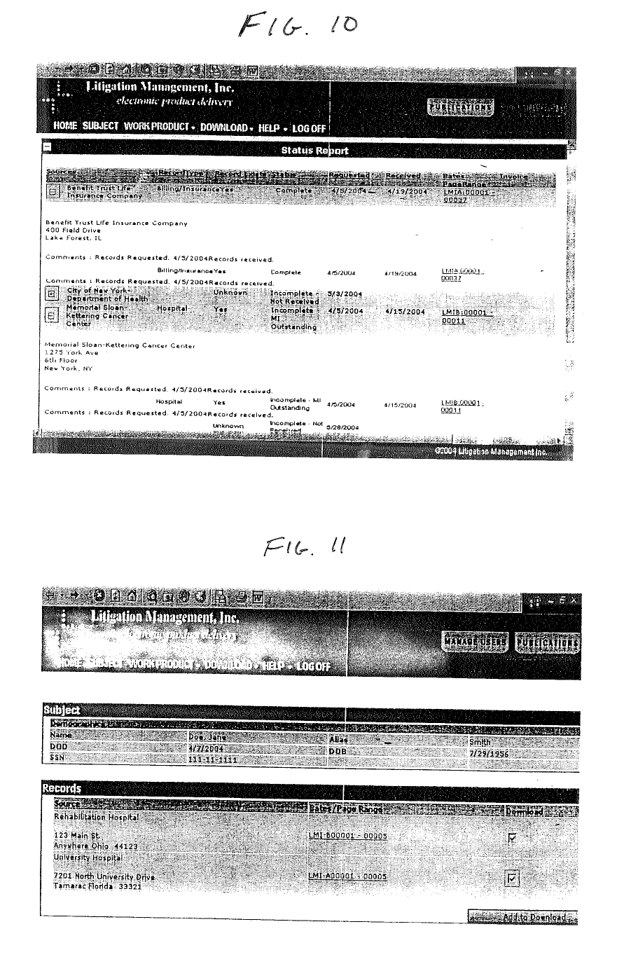

Record information is provided into the system by the system manager or other authorized parties, as shown in FIG. 1, and may be keyboard entries of data from original documents, electronic documents provided by third parties, such as deposition transcripts, which are downloaded to the system from CD, work product documents created by the system manager, documents from the court, counsel or expert witnesses, which are received electronically in Word or PDF formats, and hard copies or electronic image files of litigation documents, medical records or employment records, which are scanned using Adobe PDF formats or are otherwise downloaded to the database 12 for each subject of a litigation matter. FIG. 11 illustrates a display screen image having record information regarding a specific subject sorted by source, where a user may download the desired record information as indicated.

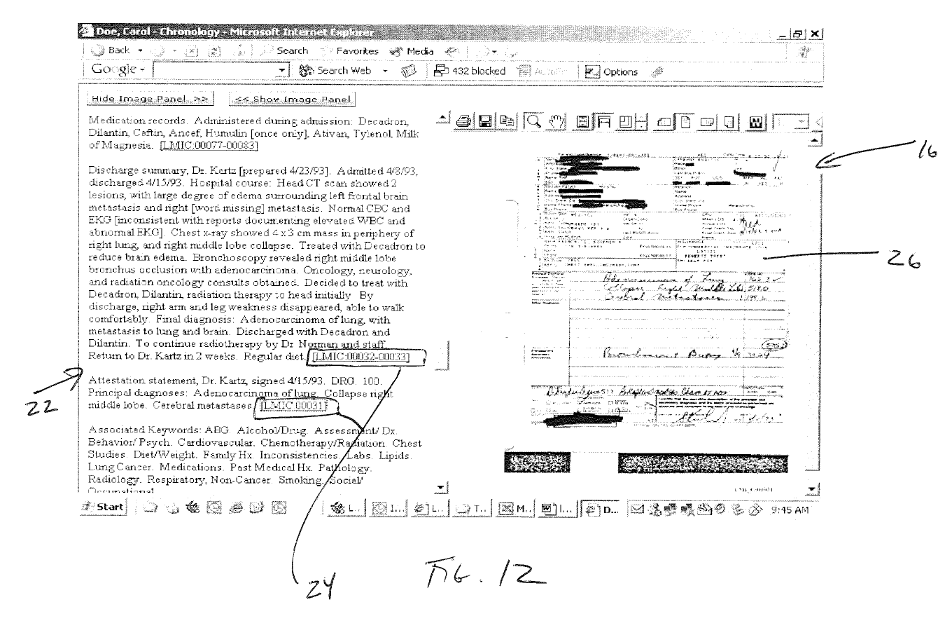

All records 16 may be viewed and sorted by their source or document type (see FIGS. 12a and 12b). As previously described and shown in FIG. 7, numerous aspects of each subject are keyed into the database, for example, name, case caption, date of birth, date of death, social security number, counsel representing. Since the system 10 makes use of a relational electronic database 12, decision makers are able to sort, view and analyze various aspects of multiple cases with multiple subjects or plaintiffs, to determine trends or risk factors which may not otherwise be readily apparent.

As shown in FIG. 12, original handwritten records 16 are keyed into the database and stored as text or work product files 22 which provide easy to read typed versions of the original handwritten documents or portions of documents. Hyperlinks 24, which contain an electronic link to the address or location of the desired document within the database, are embedded within such text files 22 so that the user, by activating the hyperlink using a mouse or keyboard, may immediately access a scanned original image file 26 of the handwritten record from which the text file was generated. Using a split screen function, as shown in FIG. 12, half of a screen may be used to view the text file 22 with the embedded hyperlinks 24, with the corresponding image file 26 on the other half screen, enabling the user to view both documents on one screen.

Alternatively, record images may be viewed in a single screen viewer format as shown in FIG. 12a. As shown, records 16 are selected for viewing from a listing sorted by their source for each subject and/or their document type. By activating a record hyperlink 24 using either a mouse or keyboard, users are asked whether they want to open or save the document, and may select how they will make use of the record 16 using an image viewer application provided within the system. Alternatively, as shown in FIG. 12b, records 16 may be selected for review by a user from a record listing. Again, by activating a Bates number range of pages, MicroSoft Internet Explorer is used to provide a listing of image hyperlinks 24. By activating or selecting one of the hyperlinks, the record image 16 is shown for review by the user in an adjacent window.

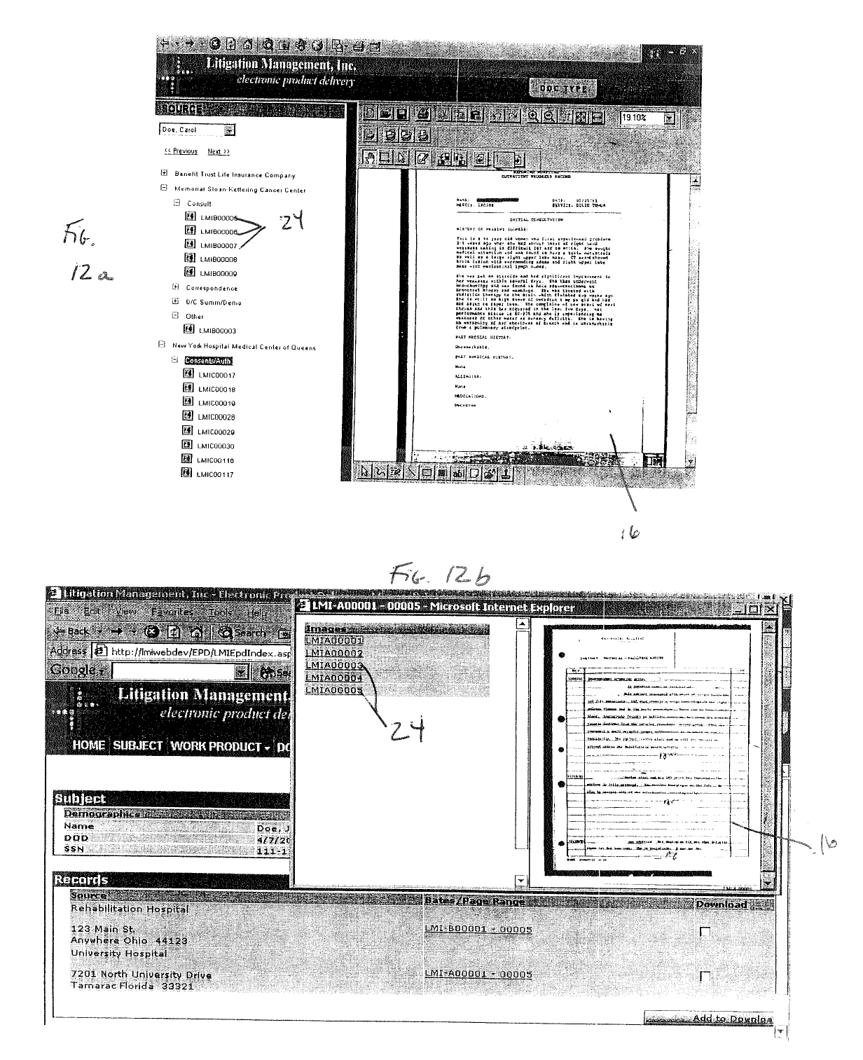

In addition to viewing the records 16, the history of records previously reviewed by a user may also be reviewed, as well as a user's document ordering archives, as shown in FIG. 6. To obtain copies, records 16 may be downloaded to the user's computer 30 or a designated office computer system, using the display screen shown in FIG. 13. Such downloads may be in a Microsoft or Adobe application such as Word or PDF, a CD or hard copies may be ordered via email from the system manager, a ZIP file may be sent to the user's computer 30 via email, as shown in FIG. 14. Alternatively, downloads in other application formats may be made, such as Summations, which is a popular litigation software tool available from CT Summation, Inc.

The database 12 of the present system 10 makes use of individualized security passwords for each authorized user which also provides the ability to update each user with new or updated information within the database since the time the user last accessed the system. Updated information can be made to appear in a different font, for easy and time saving identification by the user. Additionally, the user may request to view (or search for) record information 16 within the system 10 which may have changed since a particular date defined by the user.

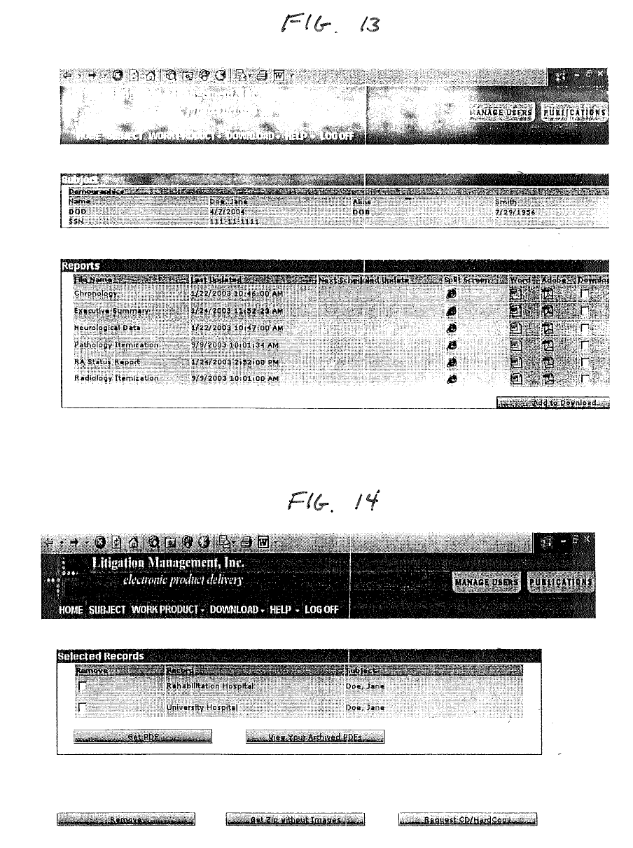

The use of the relational database 12 in the present system significantly aids in the ability to generate reports 28 from all information 16 stored within the system 10. Specialized reports or work product reports which have been prepared pursuant to instructions from the decision maker are available for viewing or downloading and/or printing in either Word or PDF formats, such as: data-driven overviews of medical information, chronology, executive summary, neurological data, pathology itemization (as in FIG. 15), records acquisition status report, a radiology itemization reports (as in FIG. 16), for example.

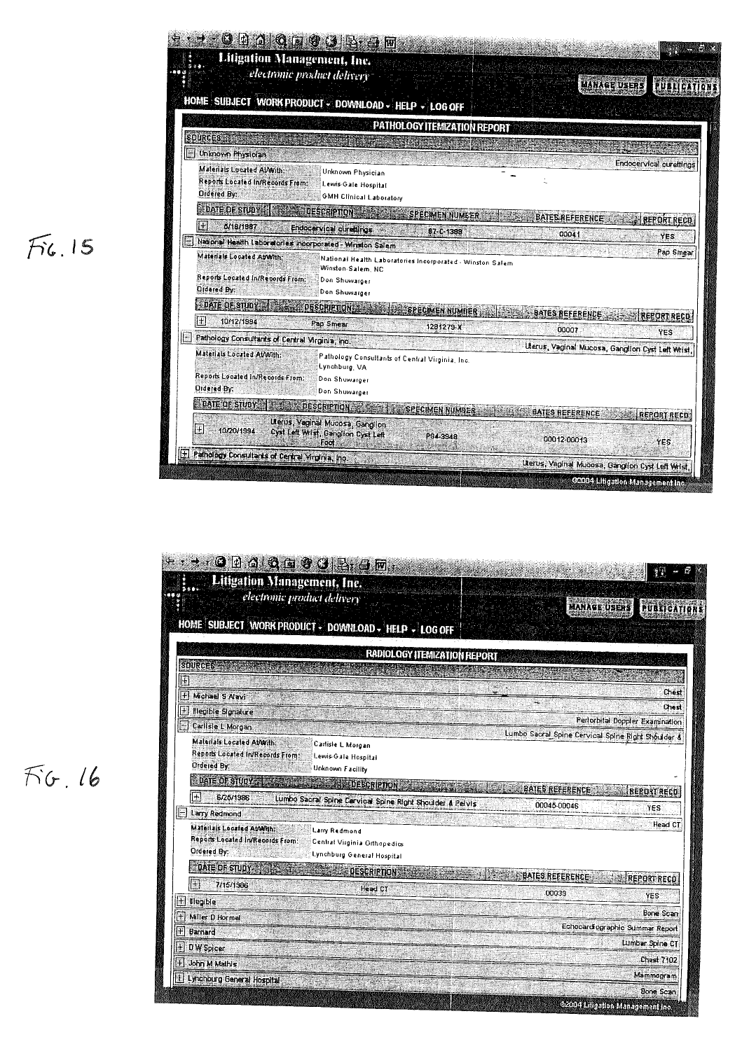

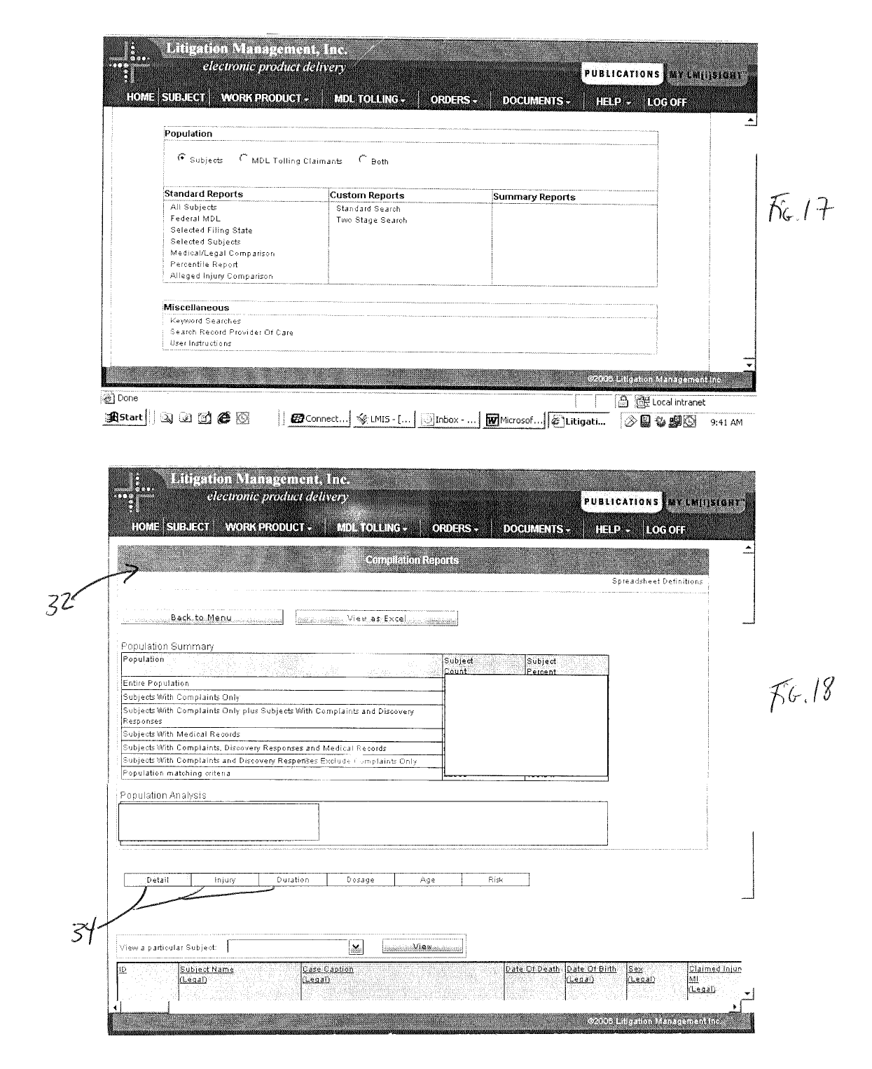

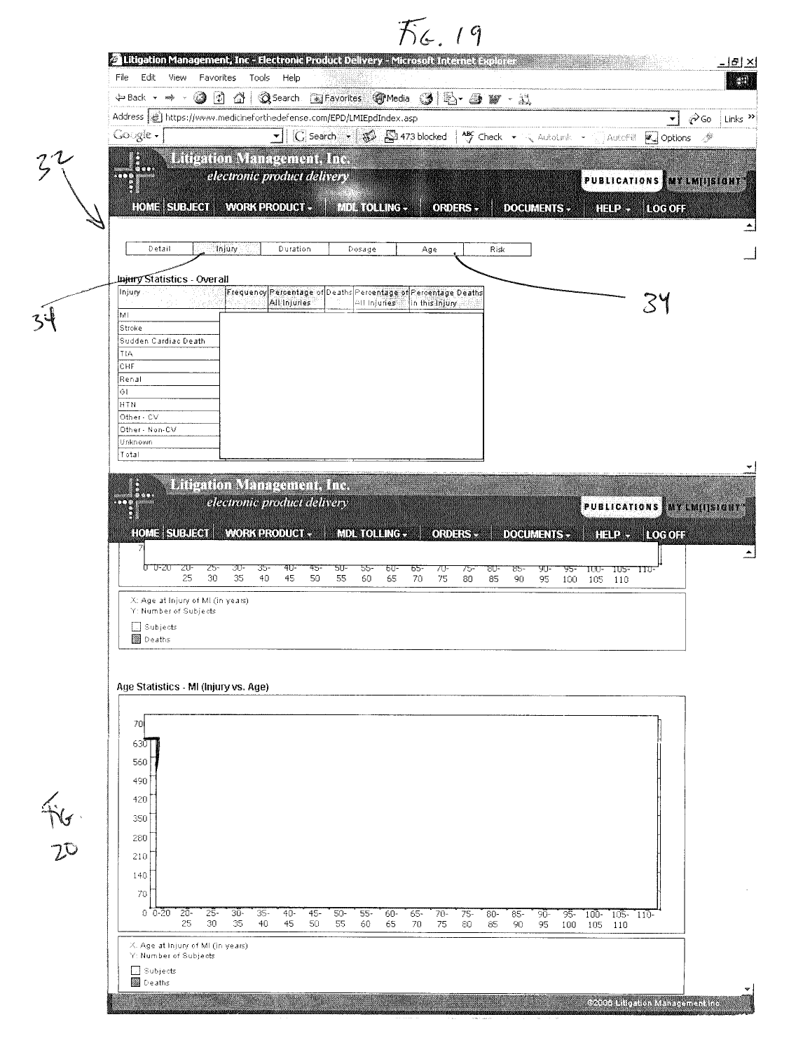

A compilation report 32 is also provided which enables the user to select, filter and sort those database fields desired for a customized report. As shown in FIGS. 17 to 21c, compilation reports 32 provide the database information selected in the desired chart format, bar graph format, or x-y graph format, as may be designated by the user. FIG. 17 illustrates a display screen image where a user may view the initial compilation report menu selections. A standard report of the selected view feature button 34 (shown with the Detail feature highlighted, but with Injury, Duration, Dosage, Age and Risk (such as smoking or family history) record information features shown as available for selection) of population information for all subjects within the database for a particular litigation matter is shown in FIG. 18, with confidential population information redacted or not shown. FIG. 19 shows a portion of the record information where the Injury view feature button 34 is selected, and specifically a table showing overall injury statistic information by the categories indicated. FIG. 20 shows a redacted bar graph of Age Statistics, where MI (myocardial infarction) is the injury graphed versus the age of designated subjects provided when using the Age view feature button 34. The axes of the graph show the age groupings of the subjects having the injury (X-axis) versus the number of subjects and their deaths (Y-axis) which would be highlighted or colored as indicated below the graph.

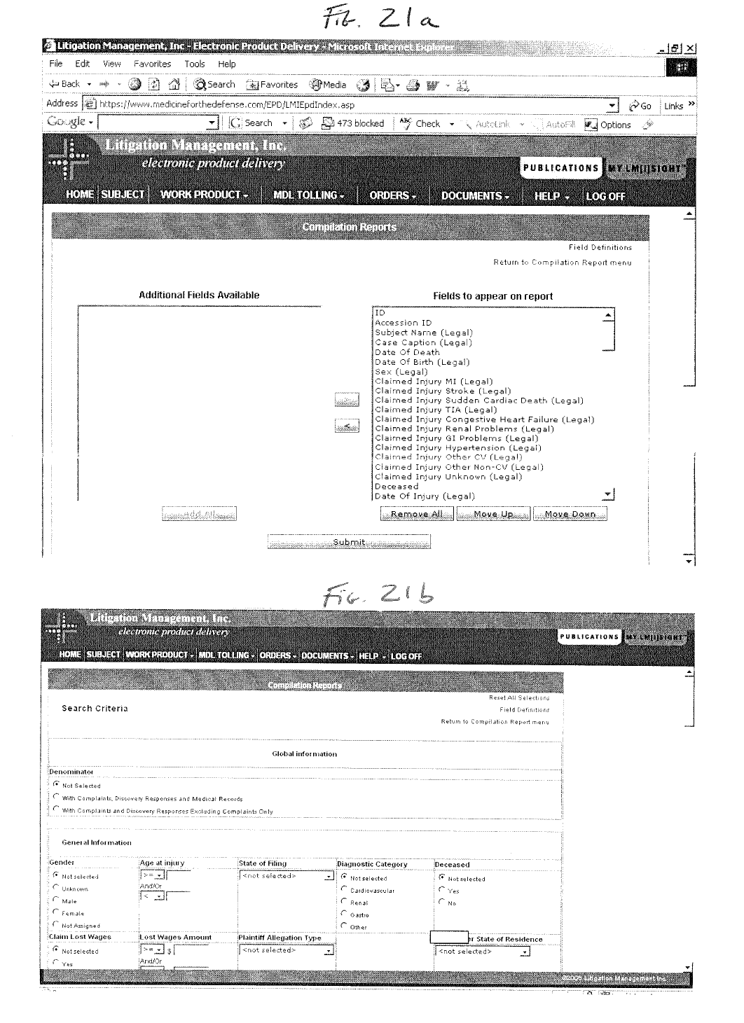

A variety of search criteria may be made available for inclusion in a customized compilation report 32. As shown in FIG. 21a, the fields which a user desires to include in a report are selected and arranged as desired. Search criteria may also be selected from a variety of available fields, as shown in FIGS. 21b and 21c.

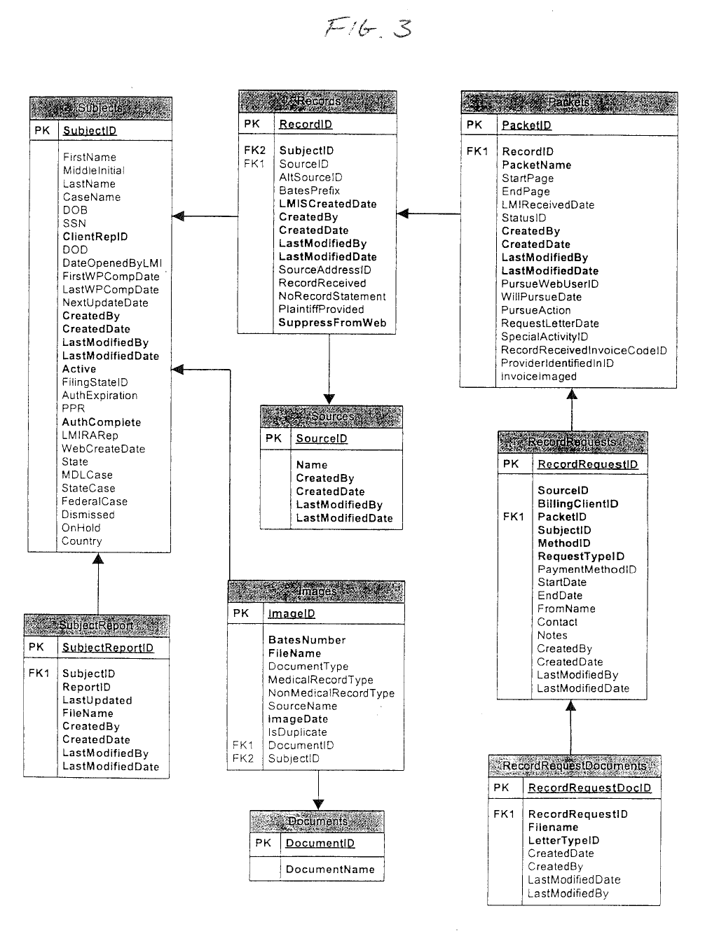

In a second application service provider embodiment of the present system 40, the litigation records are gathered and summarized under the direct supervision of the decision makers, and stored in a database maintained remotely from the decision makers, as illustrated in FIG. 2. As numerous features of the ASP embodiment mirror those of the system managed embodiment previously described, similar features are indicated by reference numbers with a prime designation, and differences with the ASP system 40 embodiment are highlighted here. The ASP system 40 embodiment enables the decision makers or system users to themselves (or using their associates or representatives) enter and create the electronic computer database 12′ using a web based application with Microsoft.NET architecture which is oriented for service based applications.

In this embodiment, a system manager or system service provider hosts a secure web site which may be accessed via the internet using, for example, the following hardware and software: Pentium III Processor or equivalent, 256 MB RAM, DSL internet connection, Windows 2000, Office 2000, Acrobat Reader, Alternatiff Image Viewer (www.alternatiff.com), Internet Explorer 6 SPI, ISPs. As shown in FIG. 2, the system manager or service provider is at a remote location from the decision maker where the database 12′ is stored, for example, on the following hardware: The database 12′ could reside on a Lefthand Networks Storage Area Network (www.lefthandnetworks.com) served via Secure Socket Layer (SSL) protocol on Dell® 1850 PowerEdge Servers.

In the embodiment of FIG. 2 of the present system 40, the improved web based computer software tool guides the user through the intricacies of reviewing and entering into a computer database 12′ a variety of litigation records 16′, including information and documents, and in particular medical documents, including images as well as text, preparing and organizing the desired analysis of such documents, and presenting the analysis in a manner appropriate for the end user or decision maker. It is anticipated that decision makers may include lawyers and legal staff preparing for trial and creating trial strategies, as well as medical and insurance personnel who assist lawyers with the documentation of a variety of medical/legal matters.

The system provides links to medical decision support tools (i.e. templates to guide users through specific medical issues, medical dictionaries, medical abbreviation lists, medical illustrations, drug information, etc.), document management support (i.e. imaging, coding, linking, etc.), as well as standard and ad hoc or customized reporting capabilities. Like the system 10 manager supported embodiment, the ASP system embodiment 10′ heavily integrates with Microsoft Word and Adobe PDF file formats. Once the decision maker establishes the necessary protocols, authorized users may access the system 10′ to view, search, download or print record information 16′ from the electronic database 12′ created by the decision maker and electronically supported by the system manager via secure internet access.

The data modules provided in this system 10′ embodiment include:

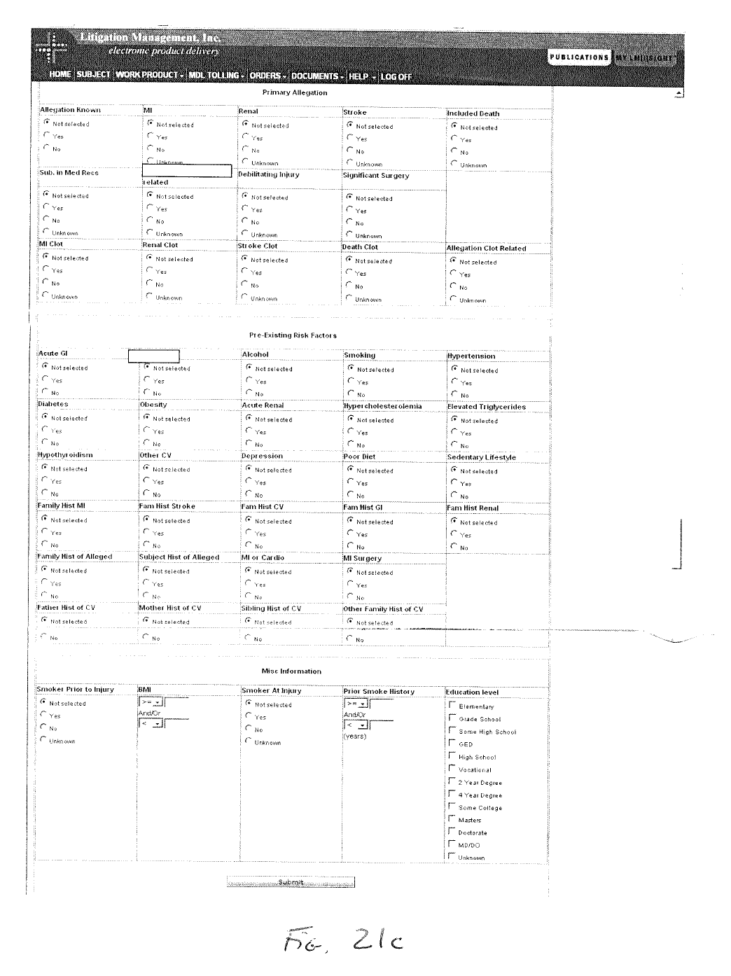

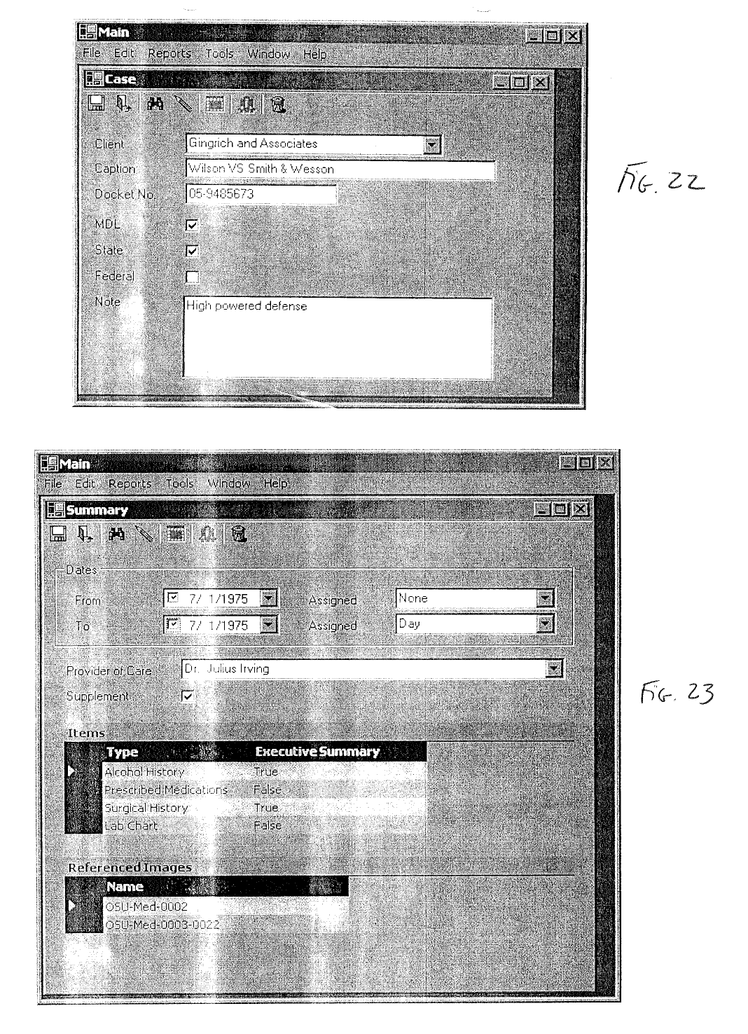

Case Management, where information regarding each litigation matter is entered, as shown in FIG. 22.

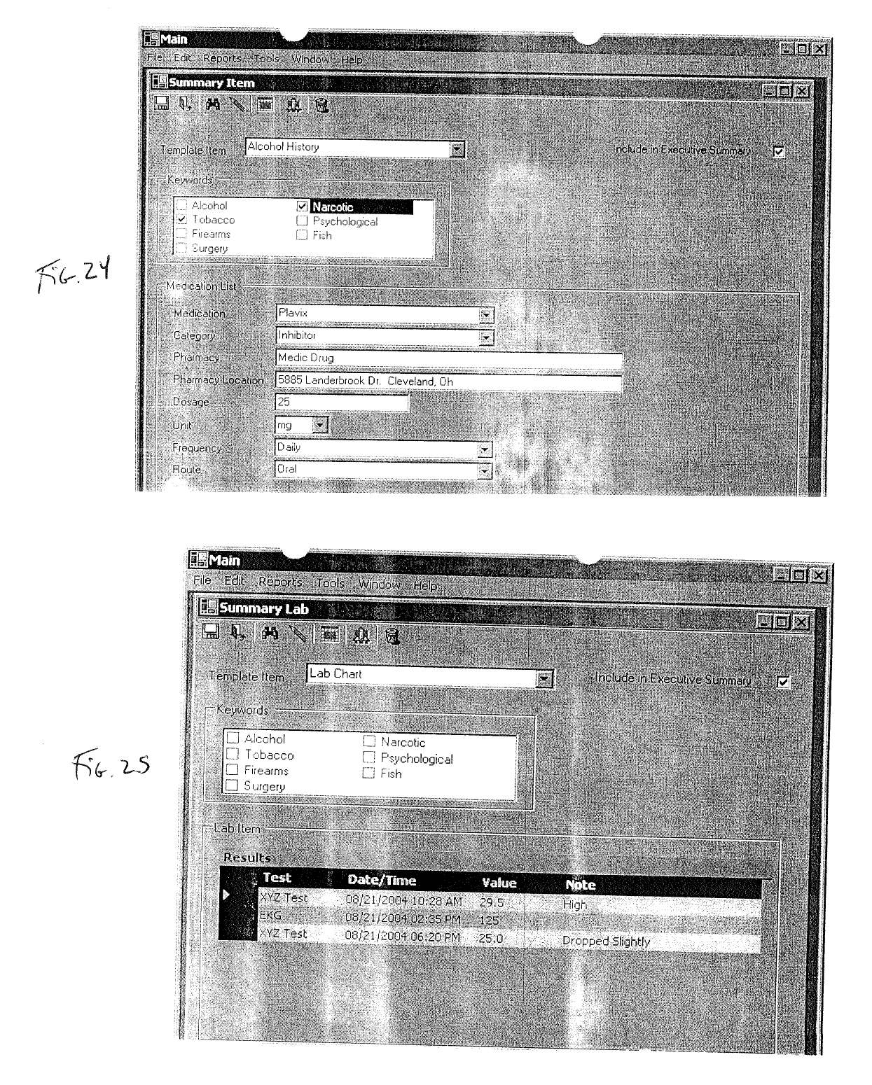

Chronology, where summary information regarding medical records is entered. The information is entered using drop down templates and menus, as shown in FIGS. 24 and 25, which supply the user with appropriate choices for proper medical record categorization and documentation, such as Alcohol History, Psychological History or Surgical History. Additionally, text box fields are also available for inputting data, as the ability to upload medical record images is also provided, as well as keyword selections for user designation of appropriate medical keyword links to the entered medical information.

Client Management, where a user establishes the desired preferences for showing work product to a client or protocols for providing authorized users with access to the system, as shown in FIG. 26, as well as general information regarding address and contact information, and system chronology and lab chart set up preferences and information.

Executive Summary, where executive summary information may be created in either text, hyperlink or image formats.

Help, to provide conventional software assistance to the user, as well as technical definitions.

Image Handling, where image files may be uploaded.

Keyword Charts, where keywords may be created and attached to various system items.

Medication Timeline, where a medication history is entered for a subject, along the lines shown in FIG. 24.

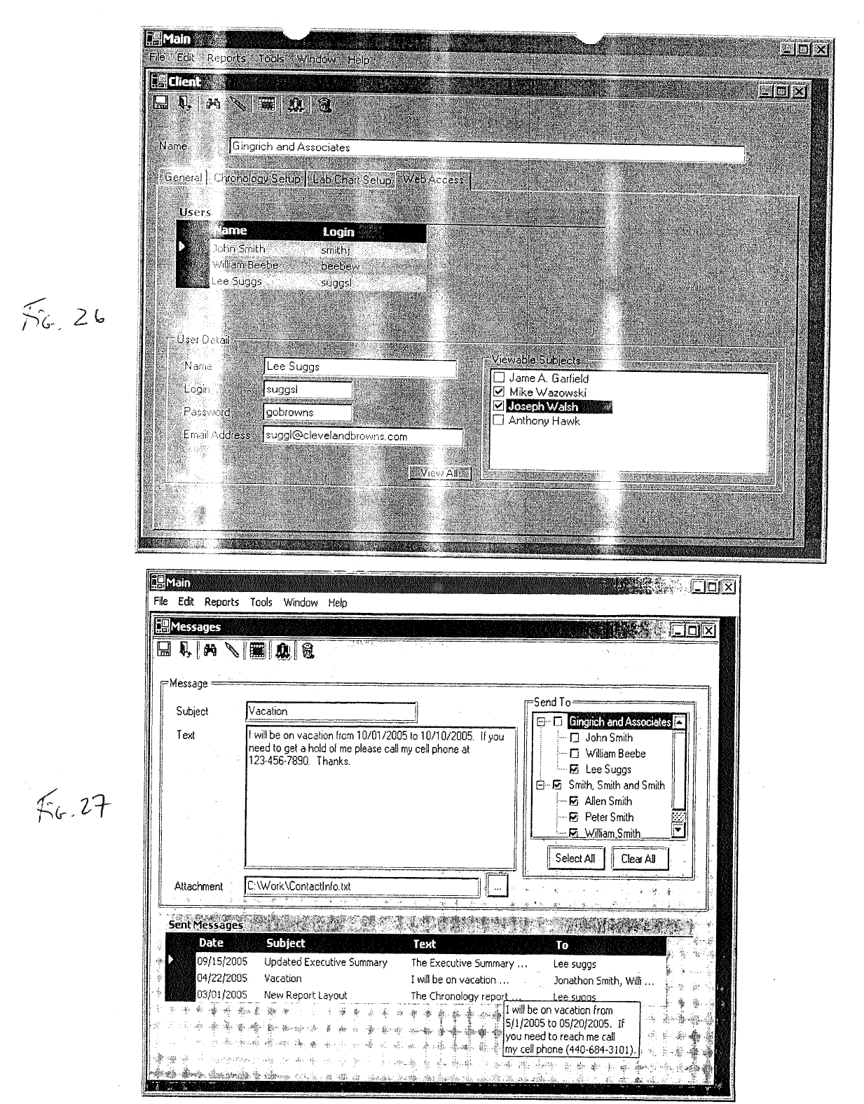

Message System, where broadcast messages may be created for single or multiple system authorized users, as shown in FIG. 27.

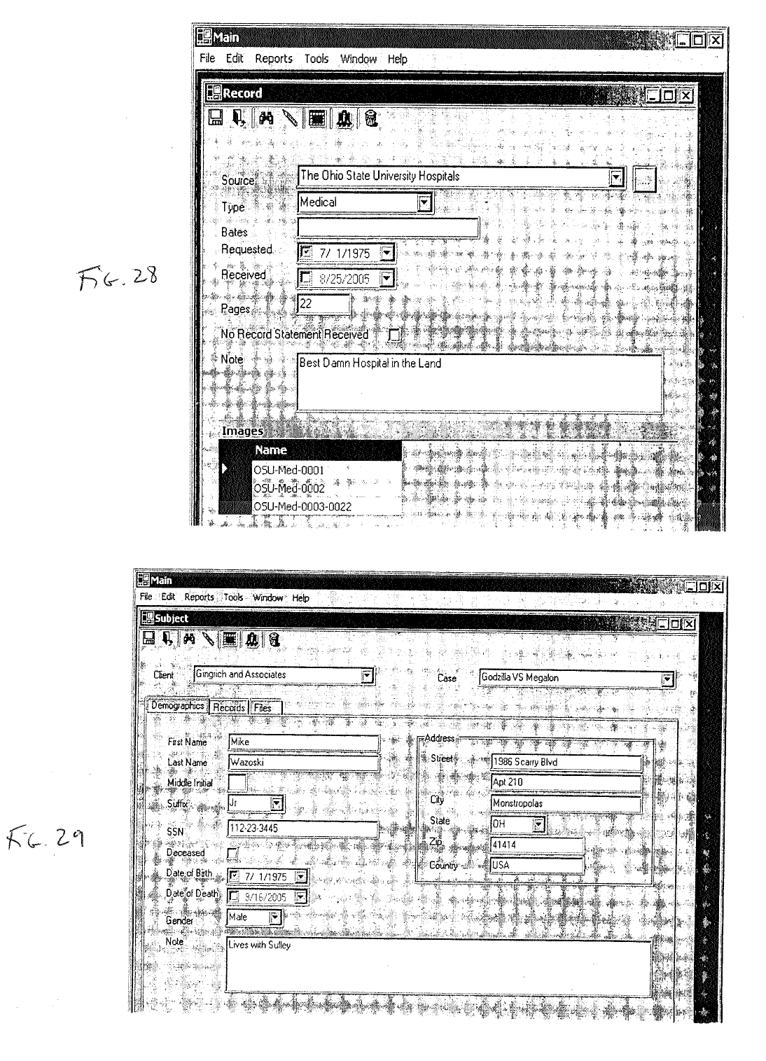

Record Management, where users enter the specific source or provider of information into the system, along with their mailing or other contact information using a side pull down menu (not shown), as well as identification numbers associated with the information (for example, Bates numbers) and its type, as shown in FIG. 28.

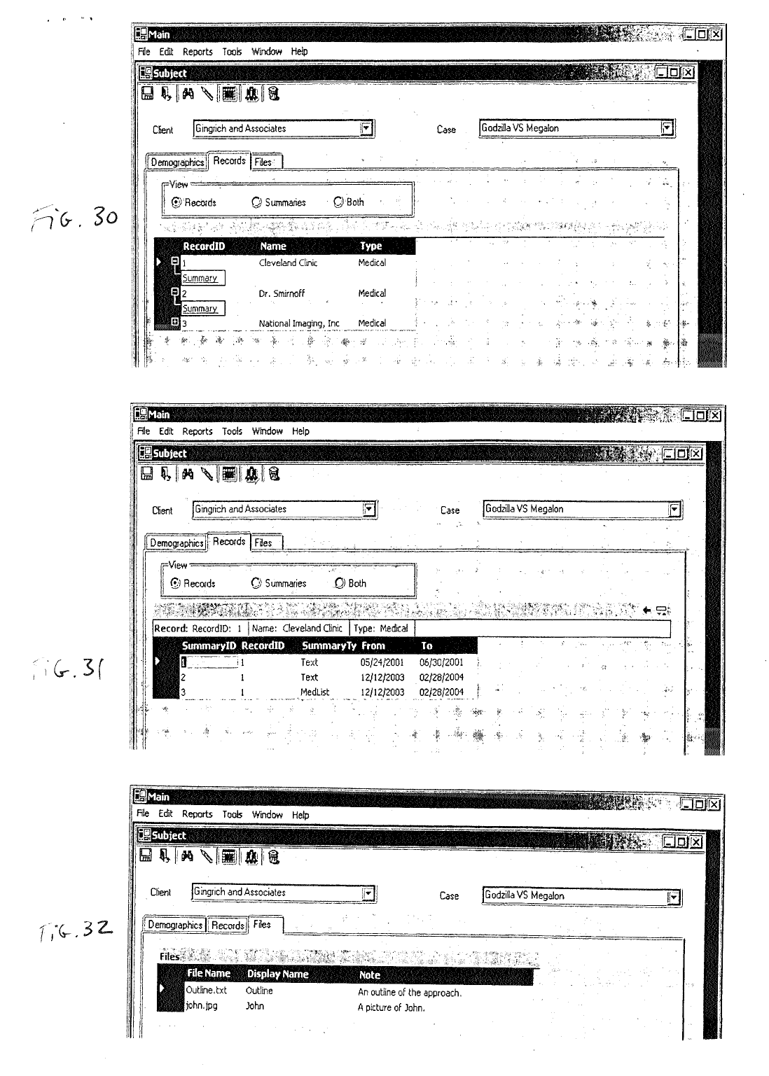

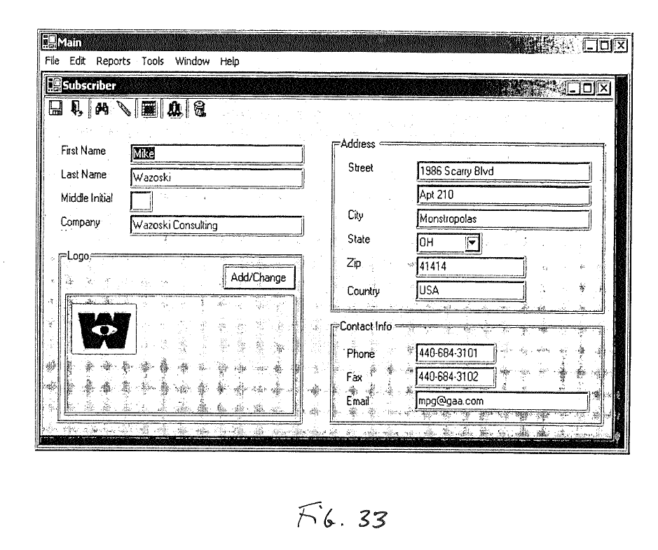

Subject Information, where subject demographic, record (in summary and expanded views) and file information associated with the medical record information is entered and tracked, all as shown in FIGS. 29 to 32.

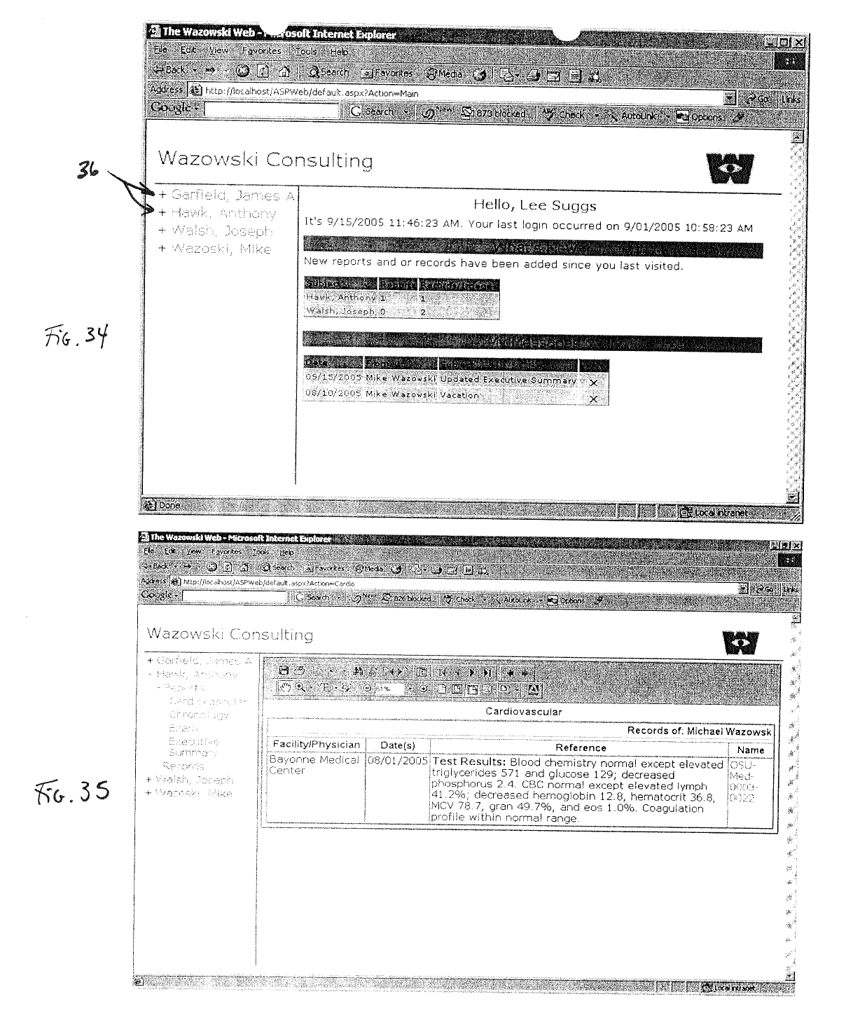

User or Subscriber Information, where information regarding the user company or service may be entered, as shown in FIG. 33.

Invoicing, where time tracking information is entered and invoices may be generated for decision makers of the system who are billing time and materials to clients.

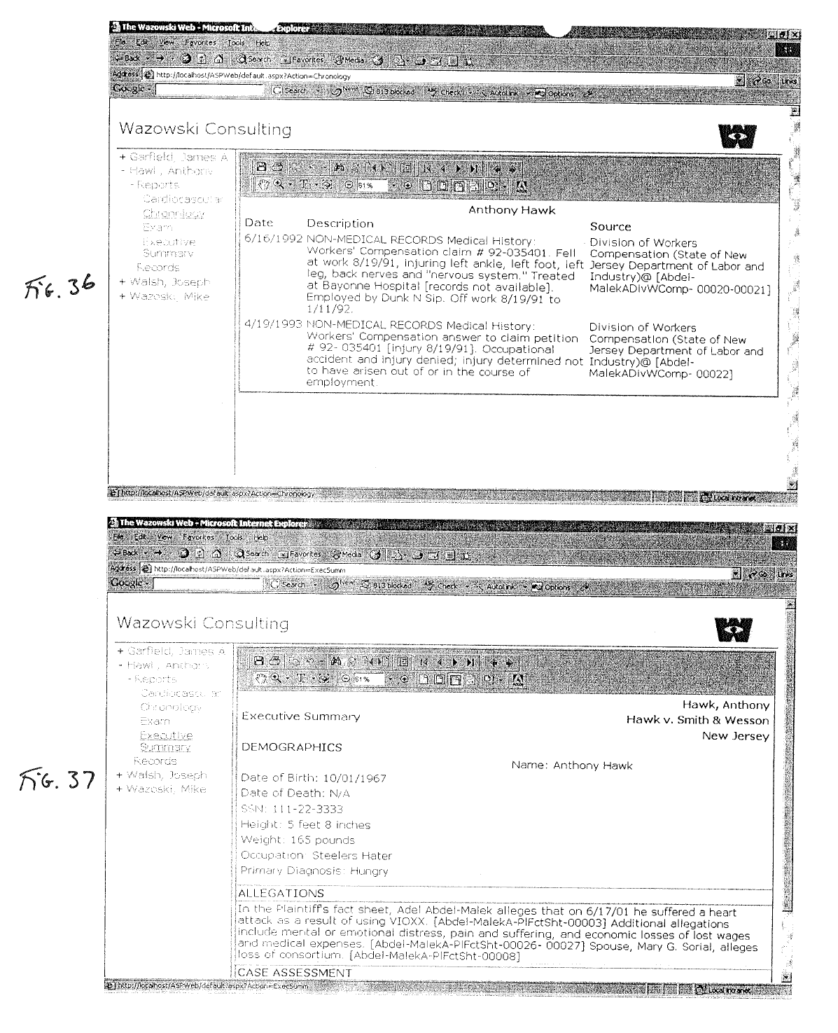

Report Generation, where users may define and produce reports concerning the medical information entered within the system, which reports are provided to the system user as shown in FIG. 35. Standard reports include a chronology, executive summary, keyword chart and medication timeline, however, additional reports, for example, test reports or other record information, may be provided as shown in FIG. 35.

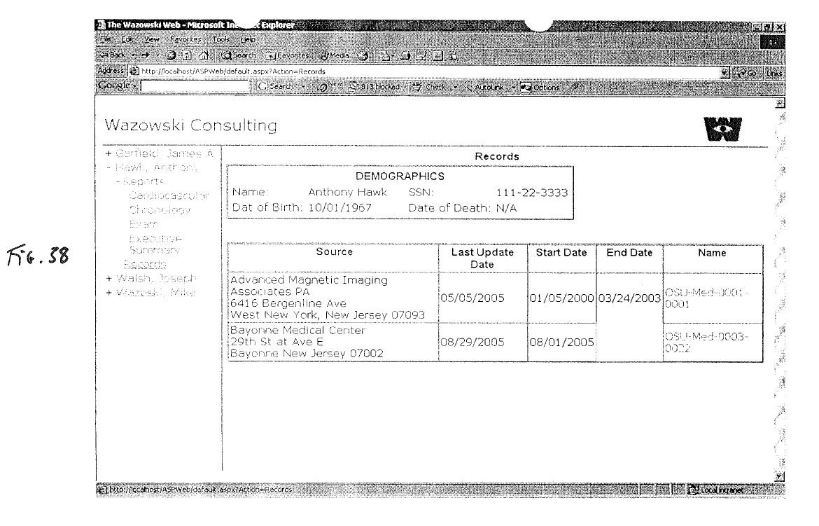

Upon accessing the system by providing the proper user identification and password, a display screen image addressed to the authorized system user is presented along the lines in FIG. 34. The litigation information regarding each subject 36 to which the user is permitted access, and has record information 16 entered into the system, may be listed for review by the user, as shown in FIG. 34. Expanding the list for each subject, enables selection of the available reports, for example the Cardiovascular report shown in FIG. 35. Additional samples showing the Chronology report, Executive Summary report and Records listing as provided by the source indicated, are illustrated in FIGS. 36 to 38, respectively.

It should be understood by those of ordinary skill in the art that each of the embodiments of the present system includes at least one computer, or more computers, having one or more processing units to operate software applications, a memory device such as a hard disk and/or server storage device to store data, output devices such as displays and printers to display and/or print outputs of requested data stored in the computer using the software applications. Input/output devices to the computer include keyboard, mouse, memory or disk drives, CD drive, scanner, facsimile transmitted information, modem, internet connections, LAN (local area network), WAN (wide area network) and/or SAN (secure area network) connections

Although the system of the present application has been described in detail sufficient for one of ordinary skill in the art to practice the invention, it should be understood that various changes, substitutions and alterations may be made without departing from the spirit or scope of the system as defined in the attached claims. Moreover, the scope of the present system is not intended to be limited to the specific embodiments described here, which are provided by way of example. As one of ordinary skill in the art will readily appreciate from the disclosure of the present system and its embodiments, other systems, processes, components, means, methods or steps presently existing or later to be developed that perform substantially the same function to achieve substantially the same result as those of the corresponding embodiments described here, may be utilized according to the present application. Accordingly, the appended claims are intended to include within their scope such other systems, processes, components, means, methods or steps.

We claim:

1. A computer system for managing litigation related information for a litigation decision maker comprising:
an electronic database containing information entered by a computer system user authorized by the litigation decision maker related to a litigation matter or matters;
said electronic database including litigation decision maker information, litigation matter information associated with a subject or individual, background information associated with the subject, and records information in both image and searchable text formats associated with the subject;
said system generating chronologies, timelines or litigation reports according to predetermined requirements established by the decision maker based upon the information included within the electronic database; and
said system substantially continuously accessible to the decision maker or an authorized user of the decision maker via the internet.

2. A method for computer user management of medical and legal information comprising the steps of:
accessing a computer system for managing medical and legal information of a computer user via the internet;
entering information related to a medical legal matter or matters associated with a computer user into an electronic database supported by the computer system, the electronic database including computer user information, potential legal case information associated with a medical subject or individual, background information associated with the medical subject, records information in both image and searchable text formats associated with the medical subject;
generating chronologies, timelines or reports according to predetermined requirements established by the computer user based upon the information entered into the electronic database; and
enabling the computer user to substantially continuously access the electronic database remotely from the computer system for viewing, obtaining by printing or electronic downloading or providing information regarding the medical and legal matter or matters via the internet.

3. The computer system of claim 1 having records information displayed to the computer user simultaneously in split screen format in both image and searchable text formats for the same records information associated with the subject.

4. The computer system of claim 1 having hyperlinks displayed within the searchable text format of records information which, upon activation by the computer user, provides the computer user with the image format for the same records information.

5. The computer system of claim 1 having specifically highlighted records information depending on each specific computer user to inform the specific computer user that the highlighted records information is newly added to the system since the specific computer user last accessed the system.
